(19) United States
(12) Patent Application Publication
(10) Pub. No.: US 2011/0318706 A1
(43) Pub. Date: Dec. 29, 2011

(54) DENTAL IMPLANT, A DENTAL IMPLANT KIT AND A METHOD OF SECURING A DENTAL BRIDGE TO THE JAW OF THE PATIENT

(75) Inventor: Izidor Brajnovic, Rydal (SE)

(73) Assignee: NOBEL BIOCARE SERVICES AG, Zürich-Flughafen (CH)

(21) Appl. No.: 13/202,759

(22) PCT Filed: Feb. 26, 2010
(86) PCT No.: PCT/EP2010/001208

§ 371 Date: Sep. 13, 2011

(30) Foreign Application Priority Data
Feb. 26, 2009 (EP) 09002744.2

(51) Int. Cl. A61C 8/00

(52) U.S. Cl. 433/174

(57) ABSTRACT

The application relates to an implant for insertion into a structure, a method for connecting a superstructure to the implant, and a kit comprising the implant and a superstructure. The implant can include a body having an external surface for apposition to bone, an apical end and a coronal end, an insertion interface at the coronal end for engagement with an insertion tool and for inserting the implant in an insertion direction, a connection interface adapted to connect the implant to a connection interface of a superstructure, and a retraction interface for engagement with a retraction member when the superstructure is positioned for connection to the connection interface and being configured for retracting the implant from an applied position in a retraction direction.

### PRIORITY INFORMATION

This application is a U.S. National Phase of International Application No. PCT/EP2010/001208, filed on Feb. 26, 2010, which claims priority to European Application 09002744.2, filed Feb. 26, 2009, the entireties of each of which is hereby incorporated herein by reference.

### FIELD OF THE INVENTIONS

The present application relates generally to the field of implants, such as dental implants, of the kind where a superstructure, such as a dental bridge, may be secured to a structure, such as a jawbone of a patient or a model of the jawbone. More specifically, the application also relates to an implant suitable for such use, to an implant kit including such an implant and to a method for connecting an implant to a superstructure.

### DESCRIPTION OF THE RELATED ART

A superstructure may be used to replace a missing body part of a patient. The superstructure may be supported by one or several implants applied in bone substance of the patient.

One application of a superstructure is a dental bridge, which may be used to replace missing teeth in a patient's jaw. Such a bridge may be secured to existing natural teeth belonging to the patient. Dental bridges may also be secured to dental implants that have been secured to the patient's jawbone. For example, one end of a bridge may be secured to a natural tooth while another end of the bridge is secured to a dental implant or to a distance piece, normally referred to as an abutment, connected to such a dental implant. A dental bridge may also be secured exclusively to dental implants, possibly indirectly via abutments. This may be the case, for example, when the patient does not have any natural teeth left. If a dental bridge is to be placed in a jaw where a number of dental implants have been screwed to the jawbone of the patient, it may happen that the top parts of the dental implants are located at height levels, which are different from planned positions of the implants. This may happen, for example, during so called immediate loading of the implants, wherein the superstructure is pre-planned before surgery and installed immediately following installation of the implants. In such circumstances, a gap between the connection interface of the implant and the connection interface of the superstructure may occur if an implant is installed deeper than was planned for when the superstructure was made. This misalignment has to be compensated for. Conventionally, this was not an issue when the superstructure was made after surgery by taking an impression to register the exact location of the installed implant. With pre-planned superstructures, this has to be compensated for. Such adjustment can be made using telescopic abutments between the superstructure and the implant. However, such telescopic abutments have in some situations a tendency to cause irritation to the soft tissue, which in turn may cause prolonged healing time.

Planned positions of the implants may be used to pre-prepare the superstructure to fit the implants, after installation, before they are actually installed. The positions of the implants can be planned using a planning software or by a model based approach, wherein implant replicas are installed in a model of the patients anatomy. Such computer and model based planning procedures are currently available via the applicant of the present inventions by the NobelGuide planning and treatment concept.

WO03061512 and WO05060862 disclose adaptable devices for connecting pre-planned superstructure to implants installed slightly differently than originally planned. Another example of how a dental bridge may be secured to the jaw of a patient is disclosed in, for example, U.S. Pat. No. 7,175,434 issued to Brajnovic.

When a dental superstructure such as a bridge is to be secured to, for example, a number of dental implants, it may be desirable that the height of the dental implants matches the lower contour of the dental bridge, or example, its connection interfaces are supported by connection interfaces of the dental implants.

Hence, an improved method for installing a superstructure to a patient, an implant kit comprising a superstructure, and an implant that can be used for securing a superstructure to a patient would be advantageous and in particular allowing for improved precision, increased flexibility, cost-effectiveness, and/or patient safety and discomfort would be advantageous.

### SUMMARY

Accordingly, embodiments of the present inventions preferably seek to mitigate, alleviate or eliminate one or more deficiencies, disadvantages or issues in the art, such as the above-identified, singly or in any combination by providing an implant, a kit including such an implant and a superstructure, and a method for retracting an implant towards a superstructure applied to a patient in order to close a gap between the implant and the superstructure.

The inventions are defined by the independent claims. According to an aspect, an implant for insertion into bone of a patient and attachment of a superstructure, comprising: a body comprising an external surface for apposition to bone, an apical end, and a coronal end; an insertion interface at the coronal end for engagement with an insertion tool and for inserting the implant in an insertion direction; a connection interface adapted to connect the implant to an connection interface of a superstructure; and a retraction interface for engagement with a retraction member when the superstructure is positioned for connection to the connection interface and being configured for retracting the implant from an applied position in a retraction direction, wherein the external surface comprises a first threaded part with at least one thread adapted to engage the bone, the retraction interface comprises a second threaded part with at least one thread, the at least one thread of the first threaded part having a first thread direction being left or right threaded and the at least one thread of the second threaded part having a second thread direction for threaded engagement of a retraction member that is threadingly engagable in the opposite direction to that of the at least one thread of the first threaded part.

The thread of the first threaded part may have a pitch angle that is equal to or larger than 45°.

The first threaded part may have a plurality of threads.

The first threaded part may have 6-14 threads, such as 8-10 threads. The at least one thread of the first threaded part may have a thread depth of 0.12 mm-0.5 mm.

The at least one thread (5) of the first threaded part (4) may have a pitch in the range of 3 mm-5 mm.

According to another aspect, an implant kit comprising, in combination: at least one implant (3) according to an aspect disclosed herein, a superstructure comprising a connection interface adapted to be secured to the implant, and a retraction member, the superstructure comprising a through-hole for the retraction member; the retraction member being adapted to engage with the retraction interface of the implant to retract the implant from an applied position towards the superstructure.

The applied position may be in a structure, such as bone or a model of bone. The bone may be, for example, a jawbone of a patient. The superstructure is in some embodiments a pre-planned superstructure. Preplanned superstructure is in this context a superstructure prepared based on planned positions of implants in bone of the patient. The preplanned superstructure is made and available before surgery to install the implants. The superstructure may be at least partially prepared using a model, wherein implants are installed in a model of the patient's anatomy where the implants will be installed. An implant installed in a model may be, for example, an implant replica, which has a connection interface, which corresponds to the connection interface of the implant that will be installed in the patient. Such connection interface of the implant or the implant replica may have a platform adapted to support a connection interface of the superstructure. The connection interface of the superstructure may comprises a seat, such as an annular substantially flat surface, a conical surface, a curved surface, etc, that is adapted to abut a mating surface of the connection interface of the implant. The connection interface of the implant may be provided on a distance piece, such as an abutment, detachably connected to the implant. Alternatively, the distance piece and the implant are provided as a single unit. Hence the implant and the distance piece may comprise a one-piece or a two-piece dental implant.

The pitch of the external thread of the retraction member and the pitch of the internal thread of the implant may be smaller than the pitch of the external thread of the implant.

The through-hole of the superstructure may comprise a support surface for the retraction member. The retraction member may comprise a fastening element, such as a fastening screw, having a head dimensioned to abut the support surface. The support surface may comprise a ledge or flange, for example, positioned within the through hole of the superstructure. The threaded portion of the retraction member may be dimensioned to pass through the through hole of the superstructure to engage a threaded portion of the implant.

According to another aspect, a method for connecting a superstructure to at least one implant or implant structure, comprises: applying at least one implant to an applied position in a structure. The at least one implant comprises a connection interface configured to connect the implant to the superstructure, and a retraction interface configured to retract the implant from the applied position towards the superstructure; applying a superstructure such that individual connection interfaces of the superstructure are supported at separate places but at least one connection interface is separated by a gap from the connection interface of at least one dental implant; and reducing or closing the gap between the implant and the superstructure.

In some embodiments, the method comprises reducing or closing the gap by retracting the at least one implant towards the superstructure. In some embodiments, the retraction is provided by connecting a retraction member to the retraction interface of the implant separated by a gap such that the retraction member abuts a portion of the superstructure. The portion of the superstructure may be provided by a flange or ledge of a through hole of the superstructure. A portion of the retraction member may be dimensioned to pass though the through hole, and another portion thereof may be dimensioned to abut said portion of the through hole.

Embodiments of the inventions provide for elimination of separate abutments for compensating for misalignments between an implant and a superstructure. This provides in turn for a more robust arrangement, for example, wherein the risk for fracture of the superstructure is reduced. Furthermore, gaps between separate components in the area within soft tissue can be eliminated or reduced. These features provide for improved conditions for osseointegration, reduced time for healing in of the implant, reduced marginal bone resorption, improved bone to implant contact area, etc. Furthermore, embodiments of the inventions provide for improved precision of the surgery and restorative procedure. This is provided by the inventive concept of first installing the implant, supporting the superstructure by supports, such as several implants, and retracting the implant to close any gap between the connection interface of the implant and the connection interface of the superstructure. According to the invention, any misalignment due to the surgical procedure should be taken care of by the surgeon, not by the dental technician. According to the prior art, the misalignment frequently has to be attended to by the dental technician. When the inventions are used in a procedure where the superstructure is pre-planned and installed at the time of installation of the implant(s), the superstructure is perceived as the reference. The superstructure may be made based on a pre-planning of the position of the implants, such as according to the NobelGuide planning and treatment concept. Any deviation of the actual position of the implant(s) compared to the planned position(s) is taken care of by retracting the implant(s) by the surgeon. In the end, the implant(s) end up as planned relative the superstructure. Consequently, the surgery is adapted to the planned bridge, rather than wise versa according to the prior art.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the inventions are capable of will be apparent and elucidated from the following description of embodiments of the present invention, reference being made to the accompanying drawings, in which:

FIG. 1 is a schematic representation of how a number of dental implants may be secured to the jawbone of a patient.

FIG. 2 is a schematic representation corresponding to FIG. 1 and further showing a dental bridge during a part of a procedure where the bridge will be secured in the jawbone of the patient.

FIG. 3 is a schematic representation corresponding to FIG. 2 and showing a subsequent stage during the fastening procedure.

FIG. 4 represents a stage following the one shown in FIG. 3.

FIG. 5 shows, in cross section, a dental implant and a threaded fastening element according to the present application.

FIG. 6 shows some other aspects of the dental implant of FIG. 5.

FIG. 7 shows, partly in cross section, an embodiment which is an alternative to the embodiment shown in FIG. 5.

FIG. 8 is a schematic cross sectional view showing how a dental bridge may be secured to the jawbone of a patient.

FIG. 9 is a view corresponding to FIG. 8 and further illustrating details of an embodiment of a dental implant.

FIG. 10 is an enlargement of a part of the dental implant illustrated in FIG. 9.

### DETAILED DESCRIPTION

Specific embodiments will now be described with reference to the accompanying drawings. These inventions may, however, be embodied in many different forms and should not be construed as limited to the embodiments set forth herein; rather, these embodiments are provided so that this disclosure will be thorough and complete, and will fully convey the scope of the inventions to those skilled in the art. The terminology used in the detailed description of the embodiments illustrated in the accompanying drawings is not intended to be limiting of the invention. In the drawings, like numbers refer to like elements.

The following description focuses on an embodiment applicable to a dental implant and a dental bridge. It will, however, be appreciated that the inventions are not limited to this application, but the inventions can be applied to other implants and superstructures applied to such implants. In the following, reference is made to a dental implant and a dental bridge. However, this is only made for illustrative purposes and should not be read as limiting except when explicitly mentioned. The implant may equally be other types of implant having similar structures as the disclosed dental implant, or other types of superstructures having similar structure for attachment to the implant as the disclosed dental bridge and dental implant

In some embodiments, an implant for insertion into bone of a patient or a model of a patients anatomy and for attachment of a superstructure, comprises a body comprising an external surface for apposition to bone, an apical end and a coronal end; an insertion interface at the coronal end for engagement with an insertion tool and for inserting the implant in an insertion direction; a connection interface adapted to connect the implant to a connection interface of a superstructure; and a retraction interface for engagement with a retraction member when the superstructure is positioned for connection to the connection interface and being configured for retracting the implant from an applied position in a retraction direction. The applied position may be an applied position in bone or a model of a patient's anatomy, such as a jawbone or a model of a jawbone. The retraction direction of the implant may be generally opposite its insertion direction. Hence, embodiments provide for compensating for misalignments between installed implants and a superstructure made before installation of the implants. A simple design for aligned mating of a superstructure to more than one implant is provided, since the retraction interface and an interface for securing the superstructure to the implant is provided by one retraction member unit per implant. Moreover, enabling the possibility to vertically adjust any one of the implants in relation to its initial position and the superstructure assures for accurate precision and may hence bridge any misalignments or gaps.

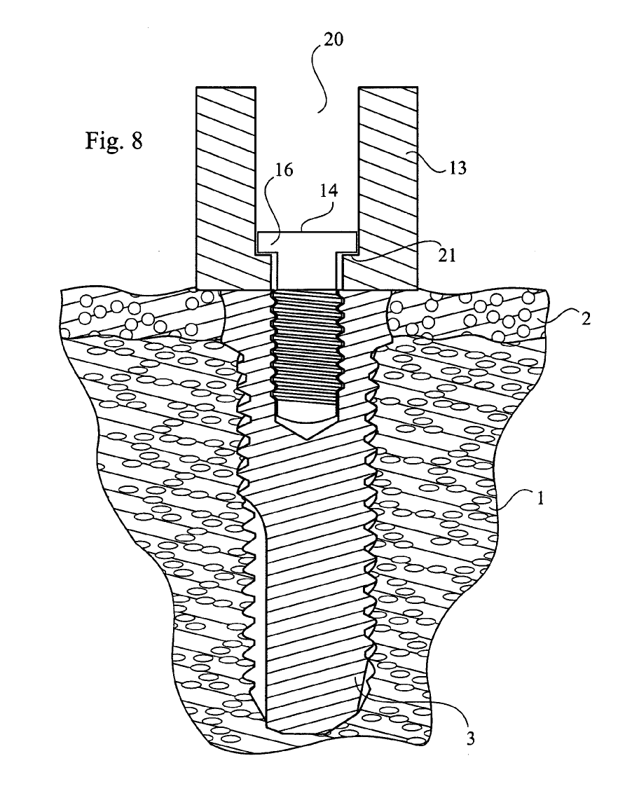

With reference to FIG. 8, a superstructure embodied as a schematic dental bridge 13 may be secured to bone, such as the jawbone 1, of a patient by means of one or several implants, such as dental implants 3. In FIG. 8, only one dental implant 3 is shown, but it should be understood that a plurality of such implants 3 may be used. In FIG. 8, a retraction member 14 embodied as a threaded fastening element is shown that has been placed in a through-hole 20 in the dental bridge 13 and brought into engagement with a retraction interface embodied as an internal thread in the dental implant 3. The internal thread is provided within a cavity of the body of the implants. The cavity has an opening located at the coronal end of the implants. Hence, the retraction interface is accessible when the superstructure, such as a connection interface thereof, is positioned for connection to the connection interface of the implant. In the embodiment shown in FIG. 8, the threaded fastening element 14 is a fastening screw with at least one external thread. The fastening element 14 has a screw head 16 dimensioned to abut a support surface 21 in the dental bridge 13 while the bridge 13 abuts a connection interface of the dental implant 3. The connection interface may be provided at the coronal end of the implant, or within the cavity of the body of the implant. Furthermore, the connection interface may be provided on a distance piece, such as an abutment, that extends at least partially through the gum 2 of the patient. Hence, the superstructure may be indirectly connected to the implant body, or example, via the distance piece.

The support surface 21 may be positioned within a through hole of the superstructure. Furthermore, the support surface 21 may be provided by a flange or ledge, such as a shoulder. Hence, the through hole may have different diameters to form the support surface. A coronal end of the through hole may have a larger diameter than an apical end of the through hole facing towards the implant 3. The different diameters of the through hole form in some embodiments the support surface 21.

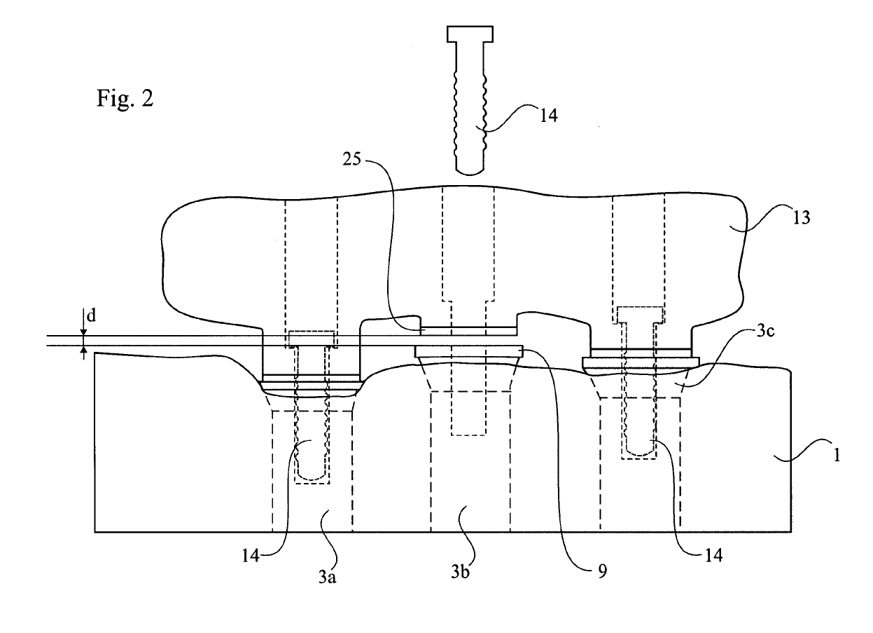

The connection interface of the implant 3 is adapted to mate or support the connection interface of the superstructure. The connection interfaces may comprise, for example, generally conical structures. Alternatively or additionally, the connection interfaces may comprise generally flat surfaces. The flat surfaces may extend in a direction generally perpendicular to the longitudinal axis of the implant 3. A tapered connection interface is disclosed in WO2008/003224, which is incorporated herein in its entirety by reference, and especially the connection interface and abutments disclosed therein. The superstructure may be supported by an annular flat surface of the implant, the tapered surface of the cavity, or an abutment. These structures are disclosed in WO2008/003224, and are therefore not further discussed herein. A generally flat connection interface is also disclosed in the embodiment of FIG. 2.

In other embodiments, the retraction member and the retraction interface forms a bayonet fitting. Alternatively or additionally, one of the retraction interface and the retraction member comprises a recess and the other comprises a mating protrusion. The recess may be a curved recess formed in a wall or surface of the retraction interface or the retraction member. When the retraction interface and the retraction member are interconnected, the implant may be pulled by force towards the superstructure for enabling better fit.

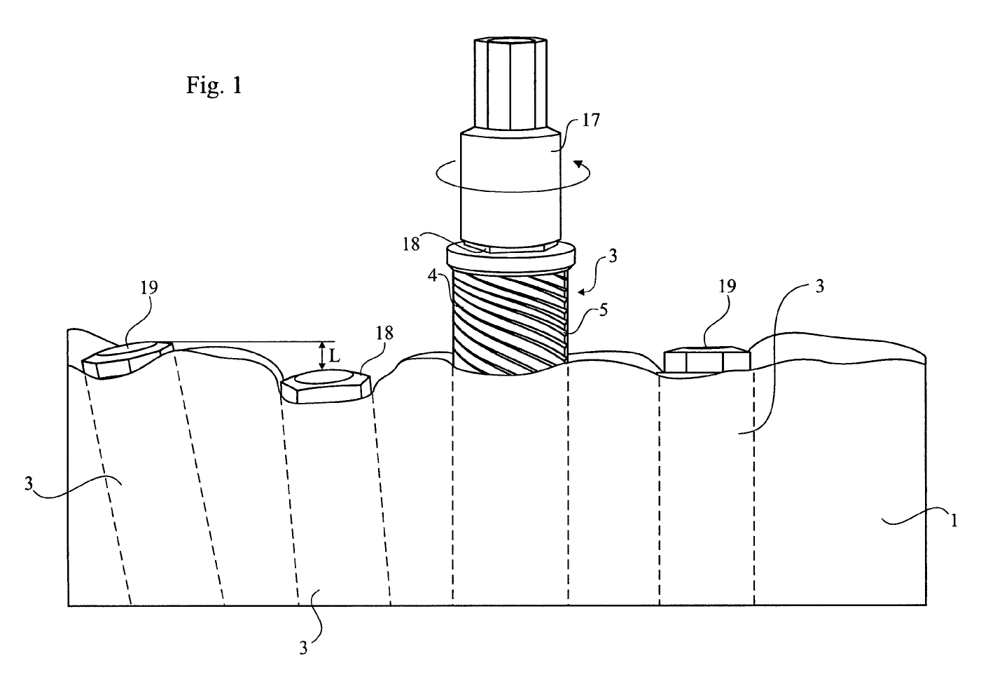

It should be noted that, in FIGS. 1-4, the soft tissue of the gum is not shown. The soft tissue has been deleted from these figures in order to avoid unnecessary complexity of the figures. It should also be noticed that the connection interface of the implant for connection to the connection interface of the superstructure can be positioned at bone level or soft tissue level.

As can be seen in FIG. 1, a plurality of dental implants 3 have been positioned in the jawbone 1. In the figure, three dental implants 3 are shown as already positioned in the jawbone 1 while yet another dental implant 3 is in the process of being screwed into the jawbone 1. The reference numeral 17 indicates an insertion tool 17 that is used to insert, and in this case, to screw, the dental implant 3 into the jawbone 1. For example, the insertion tool 17 is an implant driver. The insertion tool 17 may engage the dental implant 3 at an upper or coronal end 18 of the dental implant 3. The tool engages an insertion interface at the coronal end for engagement with the tool 17. The coronal end 18 of the dental implant 3 may be shaped with, for example, a hexagonal outer periphery that can be engaged by the insertion tool 17 with a complementary shape such that the insertion tool 17 can be used to screw the implant 3 to the jawbone of a patient. Instead of a hexagonal periphery, the coronal end of the implant 3 may have some other shape suitable for interaction with an insertion tool 17 for installing the implant 3. For example, it may have some other polygonal shape. Alternatively, there could be, at the coronal end 18 of the implant 3, structure that defines, for example, a polygonal opening shaped to be engaged by the insertion tool 17 (which would then have to be shaped to engage such an opening 19) which the insertion tool 17 may engage. Still, an alternative is a plurality of lobes and a plurality of complementary shaped protrusions.

In FIG. 1, it can also be seen that the position of different dental implants 3 may differ in the vertical dimension. The difference may occur if one or several implants are installed deeper than planned for when the dental bridge 13 was produced. As a consequence, different dental implants 3 can be separated in the vertical dimension by a distance L, as indicated in FIG. 1. A possible consequence of this can be seen in FIG. 2. In FIG. 2, a dental bridge 13 has been placed in the patient's jaw. The dental bridge 13 may be secured to the left and right dental implants 3a, 3c in a way that is, at least in principle, similar to what is showed in FIG. 8. Here, implants 3a and 3c have been installed in their planned positions, whereas as implant 3b has been installed too deeply. Since intermediate implant 3b is installed too deeply, it is separated from the dental bridge 13 by a gap indicated as d in FIG. 2. It should be understood that it is not necessarily the middle implant 3b that is separated by a gap d from the dental bridge. It could equally well be, for example, the implant 3c to the right in FIG. 2 that is separated from the dental bridge 13 by a gap or the implant 3a to the left in FIG. 2. In FIG. 2, it is shown how the dental bridge 13 may optionally include a lower distance piece 25 that is integral with the dental bridge 13 while the intermediate dental implant 3b may optionally have an upper distance piece 9. However, these are separated by the gap d. If the dental bridge 13 is fastened to the intermediate dental implant 3b in this position, the gap d may cause stress that affects the dental bridge 13, which in turn may fracture. Moreover, in the gap d, bacteria may find a foothold. If the gap can be eliminated, or at least reduced, mechanical tension in the bridge 13 can be reduced leading to reduced risk of fracture of the dental bridge. Additionally, the risk of bacterial infection can also be reduced when the gap is reduced or eliminated completely. Such infections may cause bone resorption, and ultimately implant failure as a possible consequence. The fit between the bridge 13 and the dental implants 3a, 3b, 3c would be improved if the gap d could be eliminated or reduced.

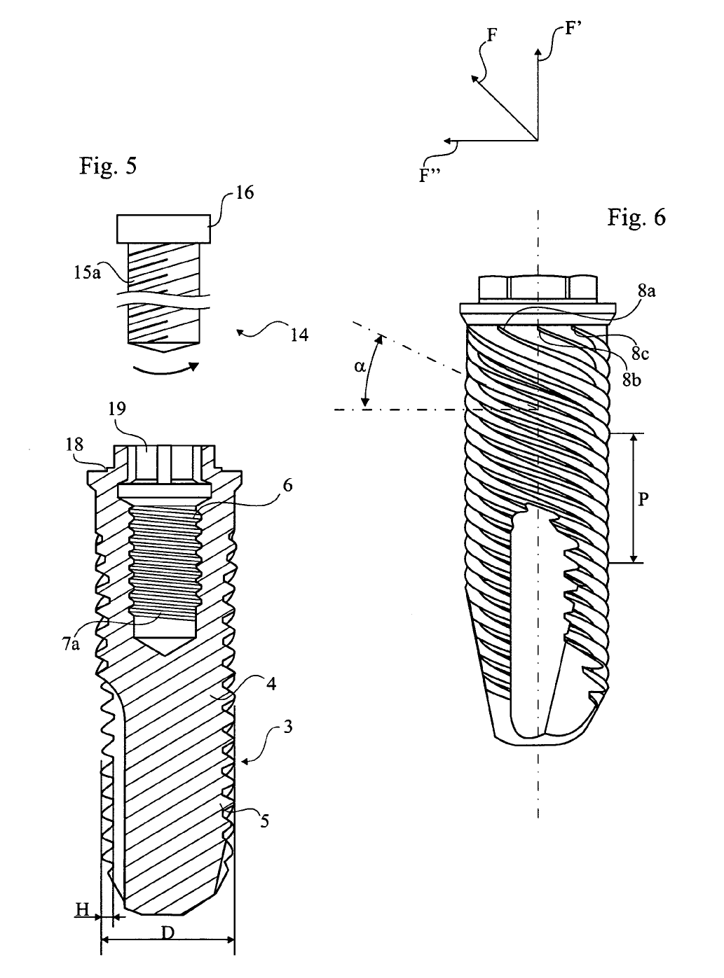

In some embodiments, for example, as illustrated with reference to the embodiment of FIG. 5, the dental implant 3 has a first threaded part 4 with at least one thread 5, and in some embodiments, one or several threads 5. The at least one thread 5 is shown as an external thread 5 adapted to engage the jawbone of a patient. The implant 3 also has a second threaded part 6 with at least one thread 7a. In FIG. 5, the thread 7a of the second threaded part 6 is an internal (female) thread 7a. The second threaded part 6 of the implant 3 is shown as being placed in part vertically above the first threaded part 4 but it should be understood that the entire second threaded part 6 of the dental implant 3 could, in principle, be located such that it is completely surrounded by the thread(s) 5 of the first threaded part 4. For reasons that will become clear, the thread(s) 7a of the second threaded part 6 has a thread direction that is opposed to that of the thread(s) 5 on the first threaded part (4). Consequently, if the thread(s) 5 of the first threaded part 4 is/are left-threaded, then the thread (or threads) 7a of the second threaded part 6 is (are) right-threaded. In FIG. 5, the threaded fastening element 14 is also shown. In FIG. 5, the fastening element 14 is a fastening screw that has an external thread 15a (or possibly external threads 15a) that is (are) adapted to cooperate with the thread(s) 7a of the second threaded part 6 of the dental implant 3. The dimensions and the thread geometry of the fastening element 14 and the internal thread(s) 7a of the second threaded part 6 of the dental implant are thus complementary. In embodiments of the invention, the diameter D of the dental implant 3 may be, for example, 3-5 mm. As an example, it may be 4 mm. Here, it should be understood that dental implants are usually standardized and are normally available in sizes according to a set standard (which may of course be subject to changes over time).

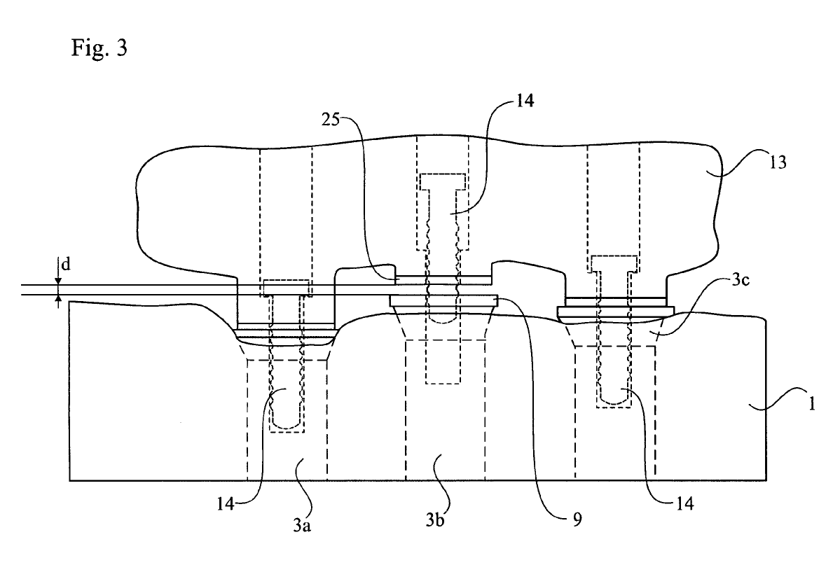

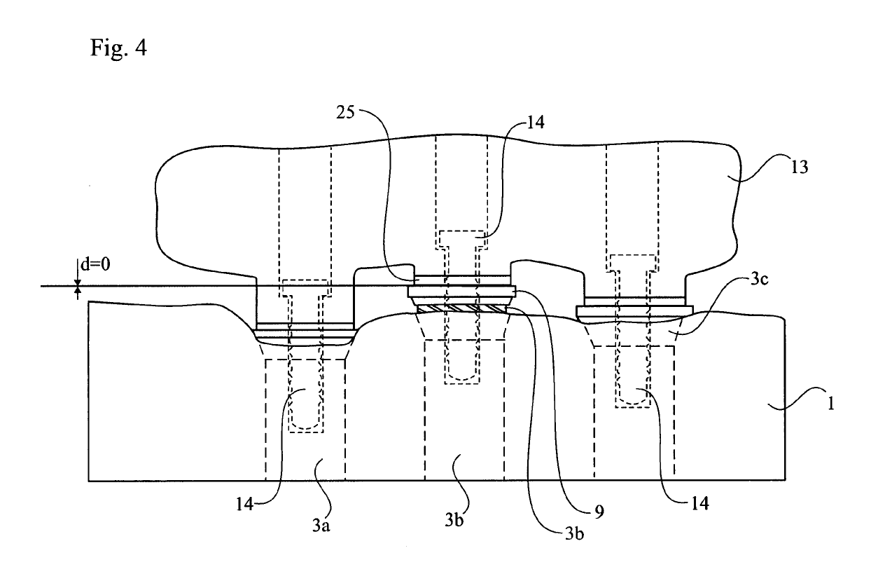

The interaction of the dental implant 3 with the dental bridge 13 will now be explained primarily with reference to FIG. 3, FIG. 4, and FIG. 8. In FIG. 3, it is symbolically indicated how retraction member, which is embodied as the fastening element 14, has been inserted in the dental bridge 13 and extends through a through hole of the dental bridge 13 and is in engagement with the dental implant 3. There is still a gap d between the dental implant 3 and the dental bridge 13. The fastening element 14 will now be screwed into the dental implant 3 such that the external thread 15a of the fastening element 14 engages the internal thread 7a on the second threaded part 6 of the dental implant 3. The fastening element 14 cooperates with the internal thread 7a of the dental implant such that the fastening element 14 is screwed into the dental implant 3. When the fastening element 14, or example, a head thereof, abuts the shoulder 19, which may provide a support surface, the shoulder 19 limits further downward movement of the fastening element 14. As a consequence, when the fastening element 14 is further screwed down the dental implant 3 will be subjected to a force that is directed upwards. Since the first threaded part 4 of the dental implant 3 is left-threaded while the internal thread 7a of the dental implant 3 is right-threaded, the dental implant 3 will now be retraced towards the dental bridge 13. In this embodiment, the dental implant 3 begins to unscrew itself from the jawbone 1 and move towards the dental bridge 13. In FIG. 4, this movement has reached its end and the connection interface of the dental implant 3, which is located the upper distance piece 9 of the dental implant 3 in this embodiment, has come into contact with the connection interface of the dental bridge 13, such as the lower distance piece 25 thereof. The gap d has thus been reduced such that d=0 as indicated in FIG. 4. It should be understood that the method can be practiced in such a way that the gap d is not entirely eliminated but merely reduced.

In some embodiments of the method of the invention, the implant to be retracted is installed deeper than planned for. The site for that implant can be prepared deeper, such as by drilling with one or several drills, than planned for. When the superstructure is installed, it is supported, for example, by a plurality of implants, whereby a gap is provided between at least one of the implants and the superstructure. For example, the superstructure may be fully supported by three implants, whereas a gap may be provided by any implant in excess of three and the superstructure. The three implants that provide support to the superstructure need not have opposing thread directions of the external thread and the internal thread, for example, when it is not necessary to adjust such implants. Hence, the method may be employed with threaded implants having a combination of left and right threaded external threads, for example, each implant having either a right or a left threaded external thread, and both having either left or right threaded internal thread. Hence, some of the implants supporting the dental bridge may have the same thread direction of the internal thread and the external thread.

In order to retract the implant 3, the retraction force or torque applied by the retraction member should be larger that the insertion force or torque required by the insertion tool 17 to insert the implant 3. In dental applications, the recommended insertion torque is normally 35 Ncm for a threaded implant. Hence, the retraction force applied by the retraction member in such an application should be at least 35 Ncm. A counter force equal to the force applied by the retraction member should be distributed to the supports of the superstructure, and thus via the superstructure itself. In order not to break the superstructure, it is important that the retraction force that is necessary to retract the implant is not too large. Providing external threads(s) with a relatively large pitch or pitch angle provides for keeping the necessary retraction force at a suitable level. Furthermore, the structure into which the implant is installed needs to withstand the retraction force. If it is too large, the structure may be damaged when the implant is retracted. A relatively large pitch angle provides for less insertion torque and consequently less retraction force compared to a thread having a smaller pitch. A relatively large pitch or pitch angle is in some embodiments provided by a thread having a thread angle a equal to or larger than 45°.

With reference to FIG. 6, the pitch angle a for the thread or threads 5 of the first threaded part 4 may be equal to or larger than 45°. Suitably, the pitch angle a for the thread(s) 5 may be in the range of 45°-60°. A large pitch angle a reduces the resistance when the dental implant 3 is unscrewed, and in some embodiments, it becomes easier to unscrew the dental implant 3 from the jawbone. With reference to FIG. 6, the force F generated by the fastening element 14 may be divided in the vertical component F′ and the horizontal component F″. A larger pitch angle a makes the vertical force component F′ larger and it is easier to make the dental implant 3 move upwards. As a consequence of the large pitch angle, the pitch P for the external thread(s) 5 of the dental implant also becomes relatively large. The pitch P (see FIG. 6) may be in the range of 3 mm-5 mm. For example, the pitch P may be 4.5 mm. Of course, it should be understood that other values for the pitch P may also be considered, for example, depending on the diameter of the body of the implant 3, and the number of external threads 5.

The pitch of the thread(s) 15a of the fastening element 14 and the internal thread(s) 7a in the second threaded part 6 of the dental implant 3 may be smaller than that of the external thread(s) 5 of the dental implant 3. In this way, it becomes easier for the internal thread(s) 7a and the fastening element 14 to overcome the opposing force and lift the dental implant 3 upwards. The total movement or retraction upwards may be in the range of, for example, up to about 0.4 mm. Both larger and smaller movements or retractions are conceivable.

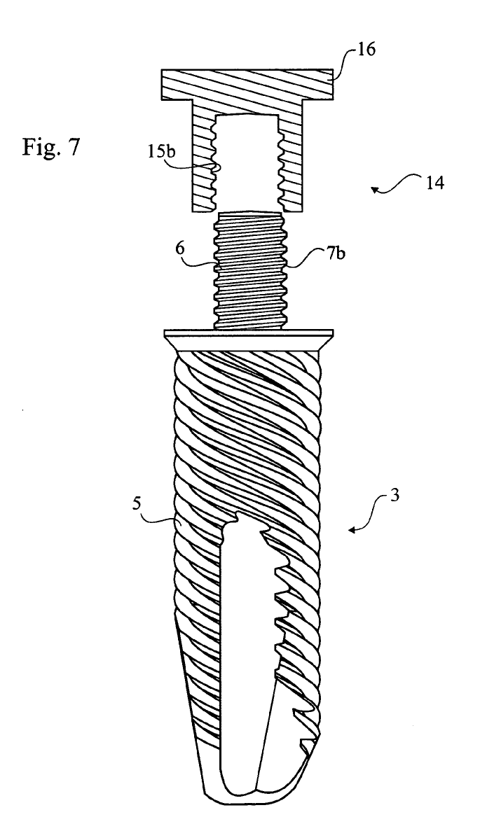

Alternative embodiments will now be explained with reference to FIG. 7. The embodiment of FIG. 7 functions in basically the same way as the embodiment explained with reference to FIG. 5. However, the retraction member, embodied as a fastening element 14, has an internal thread 15b (or internal threads 15b) and the retraction interface, embodied as a second threaded part 6 of the dental implant 3, has an external thread 7b (or external threads 7b). Also in this case, the at least one thread 5 on the first threaded part 4 of the dental implant 3 has a thread direction that is the opposite of the thread(s) 7b of the second threaded part 6 of the dental implant 3. Consequently, if the at least one thread 5 on the first threaded part is left-threaded, the thread(s) 7b is/are right-threaded. The internal thread(s) 15b of the fastening element 14 is/are adapted to cooperate with the thread(s) 7b (which is here an external thread 7b).

It can be added that, for many applications, it may be sufficient if the second threaded part 6 has only one thread 7a, 7b. In any event the retraction interface and the retraction member being interconnected an implant may be pulled by force towards the superstructure for enabling accurate fit.

In both the embodiment of FIG. 5 and the embodiment of FIG. 7, it would be possible to have a right-threaded thread 5 on the first threaded part 4 but then the thread(s) 7a, 7b on the second threaded part 6 would have to be left-threaded and also the fastening element 14 would have to be left-threaded in such a case. Since the dental implant 3 may be more of a special product than the fastening element 14, the choice can be made to make the at least one thread 5 of the first threaded part 4 a left-threaded thread 5 and use a more standardized component as the fastening element 14. However, it should be understood that the thread(s) 5 on the first threaded part 4 may also be right-threaded.

Having a right threaded second threaded part 6 has the benefit that it is a standard threading. Hence, if the superstructure is to be removed a long time, such as several years, after installation of the superstructure, the risk that the superstructure is fractured due to tightening rather than loosening a fastening screw for securing the superstructure to the implant 3 is reduced.

Some other aspects will now be explained with reference to FIG. 5 and FIG. 6. If the thread depth of the at least one (external) thread 5 on the first threaded part 4 of the dental implant 3 is relatively large, this tends to have an impact on the jawbone 1 into which the dental implant 3 is secured compared to a thread having a smaller thread depth. Relatively larger thread depth may displace less solid parts of the jawbone 1 to such an extent that the fit between the jawbone 1 and the dental implant becomes less precise, whereby osseointegration is deteriorated leading to prolonged healing time. To reduce such displacement of the jawbone, the thread depth H as measured from the tip to the root of the thread(s) 5 on the first threaded part 4 may be limited to the range of 0.12 mm-0.5 mm. In this context, the thread depth is the radial distance between the outer edge or tip of the thread and the root of the thread, as indicated in FIG. 5.

It has also been found that extensive contact between the dental implant 3 and the jawbone 1 during fastening of the dental implant 3 may result in a certain degree of frictional heat. To reduce the distance by a thread spiral in contact with bone during insertion of the implant 3, the pitch P may be chosen to be relatively large. In this context, a large pitch P may mean about 3 mm-5 mm, for example 4.5 mm.

To ensure a sufficiently effective grip between the dental implant 3 and the jawbone 1 even though the pitch is high, multiple threads may be used in the first threaded part 4. There may thus be many thread entries 8a, 8b, 8c as indicated in FIG. 6. It should be understood that each thread entry 8a, 8b, 8c represents the beginning of a separate thread spiral. The first threaded part 4 may suitably have 6-14 thread entries 8a, 8b, 8c and a corresponding number of thread spirals. In many realistic embodiments, it may have 8-10 thread entries and a corresponding number of thread entries. Thread as described herein defines a thread spiral having a thread entry.

With reference to FIG. 6, it may be noted that the pitch P should of course be understood as the vertical distance between crests of the threaded part as measured at a vertical cross section of the implant 3. The lead of the implant 3 is the vertical distance traveled by the implant 3 when the implant 3 turns 360°. Said differently, the lead is the pitch times the number of threads.

Depending on the number of threads and the pitch, the implant 3 may be fully inserted by turning the implant 1-3 full turns (one turn being 360°). The lead of the treads may be controlled by the number of thread entries and the number of thread spirals. Hence, an increased number of thread entries provides for an increased lead. For example, an effective embodiment is an implant having a body with a diameter of 3.75 mm, 8 thread entries, and a thread depth of 0.6 mm. Another effective embodiment has a diameter of 3.75 mm, 12 thread entries and a corresponding number of thread spirals, and a thread depth of 0.3 mm. The former embodiment may provide for improved initial stability compared to the latter embodiment, whereas the latter embodiment may provide for decreased time for osseointegration compared to the former embodiment. Other diameters of the implant body are also foreseeable, such as 3-5.5 mm. The number of threads may be adapted to the specific diameter in order to have a suitable pitch angle, such as described above.

In some of the illustrated embodiments, the external surface comprises a cutting flute, whereby each thread spiral comprises at least one cutting edge. However, in other embodiments, only some, or even none, of the thread spirals comprise cutting edges. Instead, the implant 3 may be installed using a thread tap.

Due to the high lead provided by embodiments of the invention, the implant need in some circumstances only be turned a few degrees in order to close the gap d.

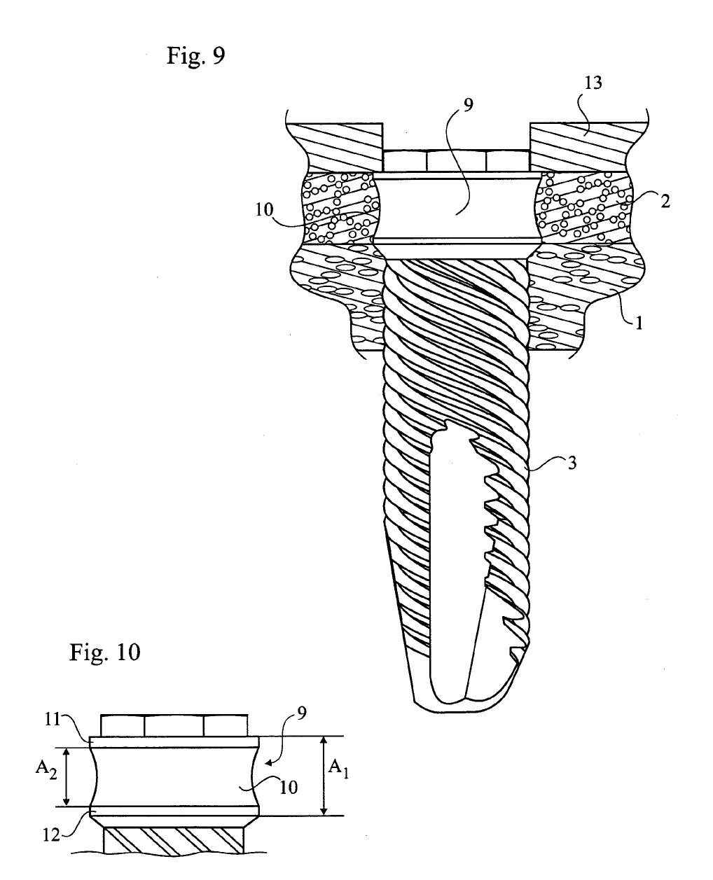

An embodiment will now be explained with reference primarily to FIGS. 9 and 10. At its coronal end, the dental implant 3 may optionally be provided with a curved distance piece 9. The distance piece 9 will be located in the region separating the jawbone from the dental bridge 13. Experience has showed that a human body strives to maintain a certain thickness of the layer of soft tissue above bone. Where the soft tissue disappears, underlying bone may resorb. Where a dental implant has been placed in the jawbone of a patient, the dental implant will be more secure if the bone does not resorb. If the dental implant 3 ends immediately above the jawbone 1, this could possibly lead to difficulties in the fit between the dental bridge 13 and the dental implant 3. One possible consequence could be that, for example, contamination and bacterial infections that could harm the soft tissue and/or the bone. For this reason, a distance piece 9 can be placed at the top end of the dental implant 3. The dental implant 3 may be placed in the jawbone 1 in such a way that the distance piece 9 will be located primarily in the region of the soft tissue (the gum) 2. The distance piece 9 may have a waist-shaped portion 10. One way of accomplishing such a waist-shaped portion 10 is by giving the distance piece a curved, such as a concave, contour as indicated in FIG. 9 and FIG. 10. The curvature allows the soft tissue 2 to attach to the distance piece 9. The distance piece 9 may curve inwardly towards the longitudinal axis of the implant 3. In this way, the distance piece 9 may give a degree of support to the soft tissue. In this way, a biological security zone may be created and the distance piece 9 will have a sealing function that prevents contamination and bacteria. In some embodiments, the waist-shaped portion 10 may have a thickness that is 70%-80% of the maximum thickness of the distance piece 9. For example, it may have a thickness that is 75% of the maximum thickness. In FIG. 10, the height A₂ of the curved (waist-shaped) section may be at least 1.8 mm. For example, it could be in the range of 1.8 mm-3 mm. For example, the height A₂ may be 2.5 mm. The reason for this is that the jawbone usually needs to have at least about 1.8-2 mm of soft tissue above the jawbone. Without such a layer, the jawbone may resorb, and in some cases, start to “creep downwards”. The distance piece 9 and the waist-shaped portion 10 should therefore have a height that is chosen with this in mind. The height A₁ of the entire distance piece 9 may be somewhat more and could be, for example, ⅙-⅕ of the total length of the dental implant 3. As can be seen in FIG. 10, the waist-shaped portion 10 of the distance piece 9 can optionally be located between an upper flange 11 and a lower flange 12. The lower flange 12 may be located at a distance above the first threaded part 4 that is, for example, 0.5 mm. Without the upper and lower flanges 11, 12, the waist-shaped portion 10 would be somewhat weaker at the end of the concavity. However, it should be understood that the upper and lower flanges 11, 12 are optional. The distance piece 9, of the surface of the distance piece 9, may be made in the TiUnite™ material that is available from Nobel Biocare AB, Sweden, although other biocompatible materials may also be considered for this purpose.

The external surface of the body of the implant 3 may be generally cylindrical. At its apical end, a tapered portion may be provided, which may facilitate insertion of the implant 3 in a cylindrical hole. For example 80-95% of the portion of the external surface for apposition to bone may be generally cylindrical, whereas the remaining 5-20% at the apical tip of the external surface may be tapered. Having a generally cylindrical body provides for maintaining substantially the same stability of the implant 3 when it is retracted from its applied position, in a cylindrical hole, towards the superstructure. In other embodiments, the external surface of the body for apposition against bone is tapered. Even if the stability may be slightly deteriorated when the implant is retracted from its applied position towards the superstructure, it may still be sufficient to obtain a desired primary stability also with a tapered body.

While the inventions have been described above in terms of a method and a dental implant, it should be understood that these categories only reflect different aspects of one and the same technology. The method could thus include steps that would be the inevitable result of using the equipment described, regardless of whether such steps have been explicitly mentioned or not.

In some embodiments, an implant kit comprises, in combination: at least one implant 3 as described above, the superstructure 13 comprising the connection interface adapted to be secured to the implant 3, and a retraction member. The superstructure 13 comprises a through-hole for receiving the retraction member. The retraction member 14 is adapted to engage with the retraction interface of the implant 3 to retract the implant 3 from an applied position towards the superstructure.

The retraction member may be a fastening element 14 and may comprise an external thread 15a. The retraction interface of the implant may comprise an internal thread 7a configured to engage the external thread of the retraction member.

The pitch of the fastening element 14 and the pitch of the internal thread 7a of the implant 3 may be smaller than the pitch of an external thread 5 of the implant 3. The retraction member may be right-threaded. The through-hole of the superstructure may comprise a support surface for the retraction member, as discussed above.

Optionally, a dental kit could include only a dental bridge and an implant 3 with two threads with opposite thread direction. Such a kit may be sold and delivered separately to a dentist or dental technician that will then select a suitable retraction member, such as threaded fastening element 14.

It should be understood that the use of a distance piece 9 with a waist-shaped portion 10 is optional. Embodiments without such a distance piece 9 are possible. Equally, it should also be understood that a distance piece as the one showed in FIGS. 9 and 10 may also be used even for dental implants 3 that do not have threads 5, 7a, 7b with opposite thread directions. However, if these features are combined, they may both contribute to achieving a good fit between a dental implant and a dental bridge.

The design of the dental implant where the implant 3 has 6-14 thread entries, a pitch of 3 mm-5 mm and a thread depth of 0.12 mm-0.5 mm is intended to be used in combination with the feature that the implant 3 has threaded parts 4, 6 with opposite thread direction but the combination of these features could also be used independently of how the dental implant is otherwise designed.

The external surface of the body of the implant for apposition to bone has been described above as having at least one thread. However, in other embodiments, the external surface does not include a thread, but at least one of a micro or nano textured or pitted surface, such as acid etched, oxidized, or blasted. In still other embodiments, the external surface is recessed, such as comprising micro threads, circular grooves, circular fins, etc. The body may be, for example, circular cylindrical, tapered, elliptical, or any other shape where the body can be retracted, for example, opposite its insertion direction, after it has been applied. This provides for retracting without screwing, such as to simply pull the implant back towards the superstructure. A bayonet fitting may provide such an embodiment.

A suitable material for the dental implant may be, for example, titanium, a titanium-based alloy or a ceramic material.

Embodiments may be practiced outside the body of the patient, for example, on a structure such as a model of anatomy of a patient where implants are planned to be installed. Such a model may comprise a model of a patients jawbone. In such embodiments, the implant 3 may comprise structures corresponding to the connection interface and the retraction interface as described above but not other features, such as threads. Such an implant maybe, for example, an implant replica. The implant replica may comprise for example, an unthreaded generally cylindrical body. The model may be used to prepare a pre-made superstructure that is made before installation of the implants in applied positions in the patient. Using the method according to the inventions on a model provides for avoidance of installing the implant replicas when a model is made, for example, by a cast or by milling. Normally, the implant replica is installed when a plaster cast is made. Instead, the implant replicas can be installed after the model has been produced. The superstructure can comprise a framework and a veneering layer. The framework may be made based on a planning of positions of the implants. Then, the positions of the implant replicas are determined based on the positions of connection interfaces of the framework. The implant 3 may be installed in a patient using a surgical template adapted to install the implant at the planned positions. Planning positions of implants, a superstructure or framework and a surgical template is described in WO2008/145293, which is incorporated herein in its entirety by reference.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, for example, elements can be conjunctively present in some cases and disjunctively present in other cases.

Although embodiments of these inventions have been disclosed in the context of certain examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. Different method steps than those described above, performing the method by hardware or software, may be provided within the scope of the inventions. The different features and steps of the inventions may be combined in other combinations than those described. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions.

1. An implant for insertion into bone of a patient and attachment of a superstructure, comprising
a body comprising an external surface for apposition to bone, an apical end, and a coronal end;
an insertion interface at the coronal end for engagement with an insertion tool and for inserting the implant in an insertion direction;
a connection interface adapted to connect the implant to an connection interface of a superstructure; and
a retraction interface for engagement with a retraction member when the superstructure is positioned for connection to the connection interface and being configured for retracting the implant from an applied position in a retraction direction, wherein the external surface comprises a first threaded part with at least one thread adapted to engage the bone, the retraction interface comprises a second threaded part with at least one thread, the at least one thread of the first threaded part having a first thread direction being left or right threaded and the at least one thread of the second threaded part having a second thread direction for threaded engagement of a retraction member that is threadingly engagable in the opposite direction to that of the at least one thread of the first threaded part.

2. An implant according to claim 1, wherein the at least one thread of the first threaded part is an external thread while the at least one thread of the second threaded part is for male threaded engagement with a female portion of the retraction interface.

3. An implant according to claim 1, wherein the at least one thread of the first threaded part is left-threaded.

4. An implant according to claim 1, wherein the thread of the first threaded part has a pitch angle that is equal to or larger than 45°.

5. An implant according to claim 1, wherein the first threaded part has a plurality of threads.

6. An implant according to claim 5, wherein the first threaded part has 6-14 threads, preferably 8-10 threads.

7. An implant according to claim 1, wherein the at least one thread of the first threaded part has a thread depth of 0.12 mm-0.5 mm.

8. An implant according to claim 1, wherein the at least one thread of the first threaded part has a pitch in the range of 3 mm-5 mm.

9. An implant kit comprising, in combination: at least one implant according to claim 1, a superstructure comprising a connection interface adapted to be secured to the implant, and a retraction member, the superstructure comprising a through-hole for the retraction member; the retraction member being adapted to engage with the retraction interface of the implant to retract the implant from an applied position towards the superstructure.

10. An implant kit according to claim 9, wherein the retraction member comprises an external thread, and the retraction interface of the implant comprises an internal thread configured to engage the external thread of the retraction member.

11. An implant kit according to claim 10, wherein the pitch of the external thread of the retraction member and the pitch of the internal thread of the implant are smaller than the pitch of an external thread of the implant.

12. An implant kit according to claim 10, wherein the retraction member is provided with threads and engaged to the implant by right threaded screwing manipulation of said retraction member.

13. An implant kit according to claim 9, wherein the through-hole of the superstructure comprises a support surface for the retraction member.

14. A method for connecting a superstructure to at least one implant, the method comprising:
applying at least one implant to an applied position in a structure, the at least one implant comprising a connection interface configured to connect the implant to the superstructure, and a retraction interface configured to retract the implant from the applied position towards the superstructure;
applying a superstructure such that individual connection interfaces of the superstructure are supported at separate places but at least one connection interface is separated by a gap from the connection interface of at least one dental implant; and
reducing or closing the gap between the implant and the superstructure.

15. The method according to claim 14, comprising reducing or closing the gap by retracting the at least one implant towards the superstructure.

16. The method according to claim 15, wherein reducing or closing the gap comprises connecting a retraction member to the retraction interface of the implant separated by a gap and rotating the retraction member such that the retraction member abuts a portion of the superstructure.

17. The method according to claim 16, additionally comprising further rotating the retraction member after the retraction member abuts a portion of the superstructure to retract the implant from the applied position towards the superstructure.

18. The method according to claim 17, wherein retracting the implant from the applied position towards the superstructure comprises unscrewing the implant from the structure.

19. An implant kit according to claim 9, wherein the at least one thread of the first threaded part is an external thread while the at least one thread of the second threaded part is for male threaded engagement with a female portion of the retraction interface.

20. An implant kit according to claim 19, wherein the at least one thread of the first threaded part is left-threaded.
